(19) United States
(12) Patent Application Publication
(10) Pub. No.: US 2004/0008694 A1
(43) Pub. Date: Jan. 15, 2004

(54) Method for implementing router interface backup with virtual router redundancy protocol

(75) Inventor: Ning Guo, Shenzhen (CN)

Correspondence Address: BACON & THOMAS, PLLC, 625 SLATERS LANE, FOURTH FLOOR, ALEXANDRIA, VA, 22314

(73) Assignee: Huawei Technologies Co., Ltd., Shenzhen (CN)

(21) Appl. No.: 10/600,454

(22) Filed: Jun. 23, 2003

(30) Foreign Application Priority Data
Jun. 23, 2002 (CN) 02124762.5

(51) Int. Cl. H04L 12/28

(52) U.S. Cl. 370/395.52; 370/390

(57) ABSTRACT

Disclosed is a method for implementing router interface backup with Virtual Router Redundancy Protocol (VRRP). The method includes the steps of: connecting multiple interfaces of a router or routers to the same LAN and adding these multiple interfaces to the same multicast group; configuring the same virtual router number and virtual IP address to these interfaces to make them join the same virtual router; selecting the main interface and backup interfaces according to their respective priorities among said interfaces; and sending VRRP multicast packets from the main interface to all backup interfaces periodically; if the priority involved in the just received VRRP multicast packet is zero or the backup interfaces have not received any VRRP multicast packet within a predetermined period, one backup interface becoming the main interface and replacing the original one. The invention implements backup between interfaces in a router or routers without affecting the original VRRP backup function between routers.

### FIELD OF THE TECHNOLOGY

The invention relates to data communication, and more particularly to a method for implementing router interface backup with Virtual Router Redundancy Protocol (VRRP).

### BACKGROUND OF THE INVENTION

As the reliability requirement of data communication is increasing, backup function of data communication device becomes a serious concern. Usually, a router implements multiple backup functions, such as router backup, interface backup and board backup etc. On the one hand, these backup functions raise the reliability of equipment; but on the other hand, development costs and maintenance costs of the system are increased.

VRRP is a tolerance protocol, which is designed for a Local Area Network (LAN) with multicast and broadcast configuration, such as Ethernet. If there are two or more routers in a LAN, hosts in the LAN can communicate with other networks through any of the routers. With VRRP, when the next-hop router of a host in the LAN is failed, another router can take the place of it in time. The continuity and reliability of communication is thus kept. The network administrator configures different routers in the same network segment with the same group number and the same virtual IP address of virtual router, thus make them form a virtual router. A virtual router is consisted of one main router and several backup routers. The main router implements actual packet re-transmission function. When the main router is failed, a backup router becomes a new main router to replace the original one.

As shown in FIG. 1 that illustrates the above-mentioned network configuration, router A, router B, host 1 and host 2 are in the same LAN. A group of routers (router A and router B) constitute a virtual router which has a virtual IP address 10.100.10.1. A host in the LAN only knows the virtual IP address, and does not know the IP addresses of router A and router B. The host in the LAN sets its default route with the IP address 10.100.10.1 of the virtual router. Therefore, the host in the LAN communicates with other networks through this virtual router.

For the virtual router, firstly, it is necessary to select a main router according to the priority of each router. A router with the maximum priority will become the main router that provides packet re-transmission service. At the same time, all the other routers will become backup routers that monitor the state of the main router at all times. When the main router is working normally, it sends a multicast VRRP packet at intervals to inform all backup routers in the same group that the main router is working at normal state. If backup routers in the group have not received the packet from the main router within a long period, the backup routers then act as main routers. If there are more than one backup router in a group, there will be multiple main routers in the beginning. In this instance, each main router compares its own priority with the priority involved in the received VRRP packet; if its own priority is less than that involved in the received VRRP packet, the router acts as a backup router, otherwise keeps its state unchanged. Through this procedure, a router with the maximum priority will be selected as the new main router, and the router backup function will be completed.

It can be seen from above, with VRRP, when a router in a LAN is failed, it will be replaced with another router automatically. Nevertheless, when there is only one router in a LAN, it is not able to implement router backup. So, it is necessary to implement interface backup in order to ensure the reliability of communication. With interface backup, when an interface of a router is failed, it can be replaced with another interface of the same router. Unfortunately, the application of present VRRP is limited to router backup only, and cannot implement backup between interfaces.

### SUMMARY OF THE INVENTION

It is an object of the present invention to provide a method for implementing interface backup with VRRP in order to overcome the shortcoming that the VRRP is only used in routers but not in interfaces. The method implements backup not only between routers, but also between interfaces with multicast and broadcast functions. The method expands VRRP functions to make a protocol satisfy two requirements for backup.

To achieve this object, a method according the present invention comprises the following steps:

1.connecting multiple interfaces of a router or routers to the same LAN and adding them to the same multicast group;

2.configuring the same virtual router number and virtual IP address to said interfaces to make them join the same virtual router;

3.selecting the main interface and backup interfaces according to the priority of each interface added to the same virtual router; and

4. sending VRRP multicast packets from the main interface to all backup interfaces periodically; if the priority involved in the just received VKRP multicast packet is zero or the backup interfaces have not received any VRRP multicast packet within a predetermined period, one backup interface becoming the main interface and replacing the original main interface.

The method of the present invention groups multiple interfaces of a VRRP router or several VRRP routers into a multicast group and configures the multiple interfaces with the same virtual router number and virtual IP address to make them constitute a virtual router. In this way, backup between interfaces has been implemented without affecting the original backup function between routers. Consequentially, no matter there are one router or multiple routers in a network, default gateway backup can be implemented. The method of the invention is simple and feasible; meanwhile it expands the application of VRRP with one protocol satisfying two requirements of backup; so it is benefit for raising the reliability of networks.

### BRIEF DESCRIPTION OF THE DRAWINGS

The present invention is illustrated by way of example and not limited in the following figures, in which:

FIG. 1 shows the network configuration with VRRP according to the prior art; and

FIG. 2 shows the network configuration according to the invention.

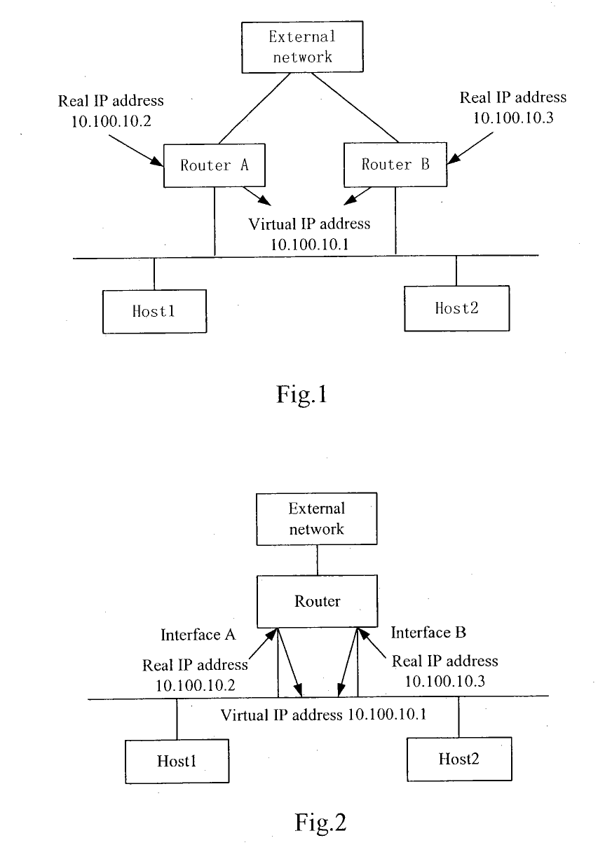

### DETAILED DESCRIPTION OF THE INVENTION

The invention is further described hereinafter, with reference to the drawings and embodiments.

FIG. 2 shows the network configuration according to the invention. Firstly, multiple interfaces of a router are connected to the same LAN and added to the same multicast group. A multicast packet sent by one interface can be received by any other interface in the same multicast group. FIG. 2 shows the condition that there are two interfaces in a router. Secondly, the same virtual router number and virtual IP address are respectively configured to the above-mentioned interfaces connected to the LAN, so the interfaces are added to the same virtual router. The interfaces in the same virtual router select the main interface and the backup interfaces according to their respective priorities.

The selection procedure of main interface and backup interfaces are as follow. When an interface is initiated, it is a backup interface at first; if it has not received any VRRP multicast packet after waiting for a period, it will become the main interface. If the interface is the owner of the IP address, i.e., the actual IP address of the interface is identical with its virtual IP address, the interface becomes the main interface directly after initiated and is configured with the maximum priority automatically. Then the main interface sends a VRRP multicast packet. Since all interfaces of a virtual router are in the same multicast group, the VRRP multicast packet sent by the main interface can be received by other interfaces in this group. If several interfaces become main interfaces simultaneously, each interface compares its own priority with the priority involved in received VRRP packet. When the priority involved in the packet is higher than the priority of the interface, the interface becomes a backup interface. After this selection procedure, the interface with the maximum priority in the virtual router becomes the main interface, and the others become backup interfaces.

The main interface periodically sends VRRP multicast packets to respond to an address resolution request for virtual IP address. It is the virtual link layer address instead of the real link layer address that the main interface responds to. At the same time, the main interface receives and re-transmits an IP packet taking the destination link address as a virtual link address. The backup interfaces do not respond to the resolution request for virtual IP addresses, and discard the IP packet taking destination link address as a virtual link address. When the main interface is failed, a VRRP packet with zero priority or no VRRP packet will be sent. In this instance, each backup interface detects whether the priority involved in the received VRRP packet is higher than its own priority; if so, the backup interface keeps its state unchanged, otherwise it becomes the main interface. In this way, it is avoided that several backup interfaces become main interfaces simultaneously. Therefore, only one backup interface becomes the main interface and replaces the original one.

If there are multiple routers in a LAN, multiple interfaces of different routers can be configured with the same virtual router number and added to the same virtual router at the same time.

The forgoing embodiment is merely exemplary and is not to be construed as limiting the present invention. The description of the present invention is intended to be illustrative, and not to limit the scope of the claims. Many alternatives, modifications, and variations will be apparent to those skilled in the art.

That which is claimed is:

1. A method for implementing router interface backup with Virtual Router Redundancy Protocol (VRRP), comprising:
(1) connecting multiple interfaces of a router or routers to the same LAN and adding the interfaces to the same multicast group;
(2) configuring the same virtual router number and virtual IP address to said interfaces to make said interfaces join the same virtual router;
(3) selecting the main interface and backup interfaces according to their respective priorities among said interfaces; and
(4) sending VRRP multicast packets from the main interface to all backup interfaces periodically; if the priority involved in the just received VRRP multicast packet is zero or the backup interfaces have not received any VRRP multicast packet within a predetermined period, one backup interface becoming the main interface and replacing the original main interface.

2. The method of claim 1, wherein said step of selecting the main interface and backup interfaces comprises the steps of:
(1) an interface directly becoming a backup interface when initiated; and becoming the main interface if it has not received any VRRP multicast packet within a period;
(2) if the virtual IP address of the interface is identical with its real IP address, the interface directly becoming the main interface after initiated, and being configured with the maximum priority automatically; and
(3) if multiple interfaces become main interfaces simultaneously, each interface comparing the priority involved in the received VRRP packet with its own priority; if the priority involved in the received VRRP packet is higher than its own priority, the interface becoming a backup interface.

3. The method of claim 1, further comprising: judging whether the priority involved in the VRRP packet received by a backup interface is higher than the priority configured to the backup interface, if so, keeping the state of the backup interface unchanged; otherwise making the backup interface become the main interface.
